(19) United States
(12) Patent Application Publication
(10) Pub. No.: US 2006/0197442 A1
(43) Pub. Date: Sep. 7, 2006

(54) ELECTRO-OPTICAL MATRIX DISPLAY DEVICE INCLUDING A CONTROL CIRCUIT ARRANGED ON A LONGITUDINAL END PORTION OF THE SUBSTRATE AND CONTROL CIRCUIT FITTED TO SAID DEVICE

(75) Inventors: Giovanni Longa, Neuchatel (CH); Jerome Fabrizio, Neuchatel (CH); Alain Hamm, Lignieres (CH)

Correspondence Address: SUGHRUE MION, PLLC, 2100 PENNSYLVANIA AVENUE, N.W., SUITE 800, WASHINGTON, DC, 20037, US

(73) Assignee: EM MICROELECTRONIC - MARIN SA

(21) Appl. No.: 11/276,417

(22) Filed: Feb. 28, 2006

(30) Foreign Application Priority Data
Mar. 2, 2005 (EP) 05004551.7

(51) Int. Cl. H01J 1/62

(52) U.S. Cl. 313/506

(57) ABSTRACT

The invention proposes an electro-optical matrix display device (10) including at least one bottom substrate plate (12) of overall rectangular shape carrying an electro-optical layer, a series of transverse electrodes (16) and a series of longitudinal electrodes (18) forming a display matrix (11), and including a control circuit (22) which is fixed to the bottom substrate plate (12) and which includes connection pads (26) connected to the two series of electrodes (16, 18) by conductive paths (41, 42, 44, 46, 48), one part (S_{C}) of the connection pads (26) being dedicated to addressing the columns (C) of the matrix (11) and another part (S1_{L}, S2_{L}) of the connection pads (26) being dedicated to addressing the lines (L) of the matrix (11), characterized in that the control circuit (22) is arranged on a longitudinal end portion (36) of the bottom substrate plate (12), and in that the connection pads (26) addressing the columns (C) are connected to the transverse electrodes (16) and the connection pads (26) addressing the lines (L) are connected to the longitudinal electrodes (18).

The invention also proposes a control circuit (22) to be fitted to the display device (10).

This application claims priority from European Patent Application No. 05004551.7 filed Mar. 2, 2005, the entire disclosure of which is incorporated herein by reference

The invention concerns an electro-optical matrix display device such as a liquid crystal cell (LCD) comprising an overall rectangular substrate plate and a control circuit.

The invention concerns in particular a “chip on glass” type display device, i.e. a device wherein the control circuit is arranged directly on one face of the substrate plate, and more specifically of the type which is fitted with a single control circuit for addressing lines and columns.

This type of display device is well known and is widely used, in particular in portable electronic apparatus such as portable telephones, watches, remote controls . . . All of these apparatus are tending to be miniaturised, such that the surface dimension of the display device can be inconvenient. This is particularly true in the case of a narrow rectangular display device whose longitudinal dimension is several times larger than the transverse dimension.

One example of this type of display device is disclosed and shown in US A 2002/075439.

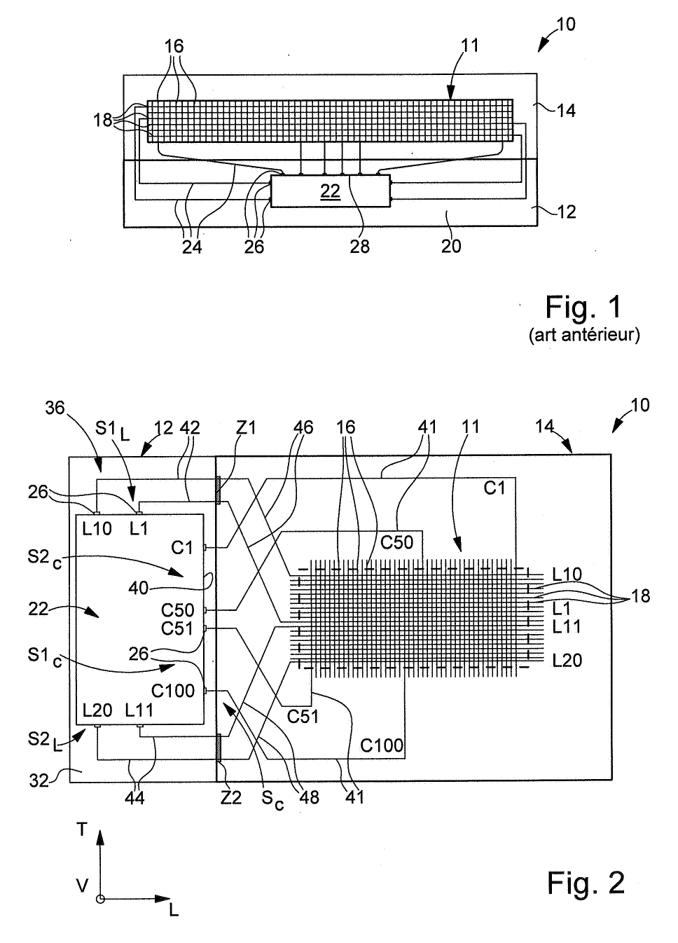

Another example is schematically shown in FIG. 1 of the present Application. Generally, the display device 10 comprises a bottom substrate plate 12 onto which a top substrate plate 14 is bonded so as to trap a layer of liquid crystals. The inner faces of the two plates respectively carry transverse electrodes 16 forming the columns of matrix 11 and longitudinal electrodes 18 forming the lines of matrix 11. Matrix 11 forms the active display zone of the device. The transverse width of bottom plate 12 is larger than the width of top plate 14 which defines, on bottom plate 12, an uncovered transverse end portion 20 onto which a control circuit 22 is fixed. Conductive paths 24 connect connection pads 26 of control circuit 22 to the associated electrodes 16, 18.

In order to minimise the surface dimension of display device 10, the connection pads 26 arranged on the main edge 28 of control circuit 22, on the matrix side, are connected to the closest and most numerous electrodes, i.e. transverse electrodes 16 which thus form the columns. The other connection pads 26 of control circuit 22 are thus connected to longitudinal electrodes 18 which form the lines.

It will be noted that the electrodes forming the lines, addressed by dedicated connection pads of the control circuit, can be designated by the term “common”, and the electrodes forming the columns, addressed by dedicated connection pads of the control circuit, can be designated by the term “segments”.

The control circuits are designed in accordance with this connection mode, i.e. the connection pads located on the main edge are dedicated to addressing the columns, and the connection pads located on either side of the main edge are dedicated to addressing the lines.

This is of non-negligible importance since, because of the design of the control signals, the electronic circuits used for addressing a line, or common, must be much more powerful than those used for addressing a column, or segment. The control circuit is thus chosen as a function of the number of lines that it is capable of addressing, so as to minimise its complexity, cost and power consumption.

However, certain new applications necessitating display devices that are particularly narrow transversely, require the control circuit to be mounted at the longitudinal end of the display device. The connection pads addressing the columns are then connected to the longitudinal electrodes, and the connection pads addressing the lines are connected to the transverse electrodes.

This type of assembly is expensive since, as the number of transverse electrodes is much greater than the number of longitudinal electrodes, the control circuit has to be oversized, i.e. include a large number of dedicated line addressing connection pads, which leave a large number of unused dedicated column addressing connection pads. The silicon surface necessary to make this control circuit is larger thus, in addition to the higher cost, this causes an encumbrance for the top circuit.

It is an object of the invention to overcome these drawbacks by proposing a display device having a reduced surface dimension while minimising cost price thereof.

Thus, the invention proposes an electro-optical matrix display device including at least one bottom substrate plate of overall rectangular shape carrying an electro-optical layer, a series of transverse N electrodes and a series of longitudinal M electrodes forming a display matrix, and including a control circuit which is fixed to the bottom substrate plate and which includes connection pads connected to the two series of electrodes by conductive paths, one part of the connection pads being dedicated to the addressing the matrix columns and another part of the connection pads being dedicated to addressing the matrix lines, characterized in that the control circuit is arranged on a longitudinal end portion of the bottom substrate plate, and in that the connection pads addressing the columns are connected to the transverse electrodes and the connection pads addressing the lines are connected to the longitudinal electrodes.

The display device thereby formed minimises the number of dedicated line addressing connection pads on the control circuit, which means that that a more economical control circuit consuming less energy can be used.

According to another feature of the invention, the control circuit includes a transverse edge provided with dedicated column addressing connection pads, the dedicated line addressing connection pads being arranged on at least one side of the dedicated column addressing connection pads.

This feature enables the display device to use a conventional display circuit which minimises the cost thereof.

According to another feature of the invention, part of the line addressing connection pads are connected to the corresponding longitudinal electrodes via a vertical connection zone which extends along a longitudinal direction.

This feature enables the addressing order of the line addressing connection pads to correspond to the physical order of the longitudinal electrodes, to facilitate the control circuit programming operations.

According to another feature of the invention, the control circuit package includes a transverse edge provided with dedicated line addressing connection pads, the dedicated column addressing connection pads being arranged on at least one side of the dedicated line addressing connection pads.

This feature enables a more compact display device to be obtained along the transverse and longitudinal directions.

The invention also proposes a control circuit designed to be fitted to the aforementioned display device.

Other features and advantages of the present invention will appear more clearly upon reading the following detailed description, made with reference to the annexed drawings, given by way of non-limiting example and in which:

FIG. 1 is a top view which shows schematically a display device according to the state of the art;

FIG. 2 is a top view which shows schematically the display device made in accordance with the teaching of the invention according to a first embodiment;

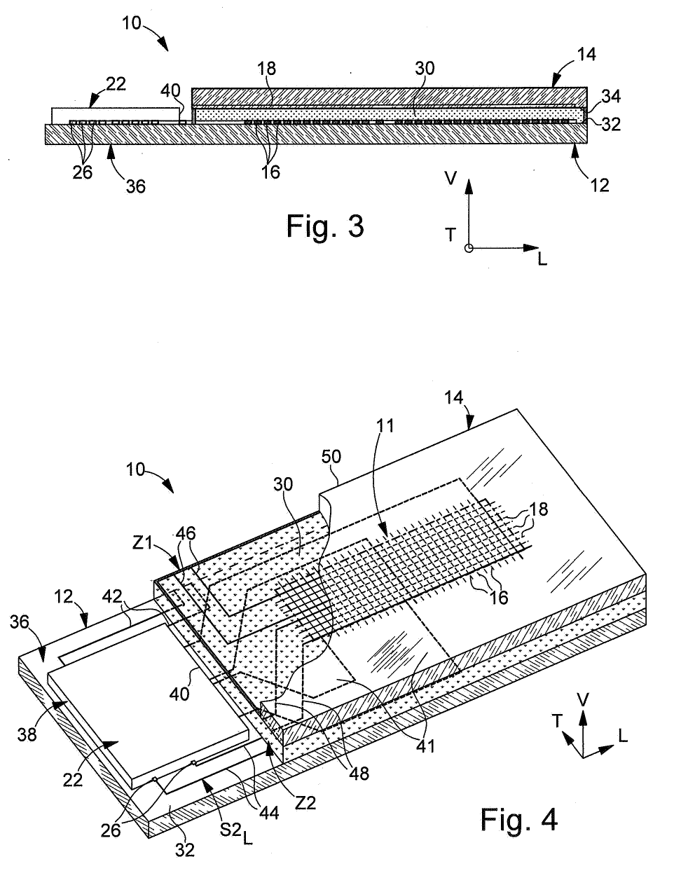

FIG. 3 is a vertical longitudinal cross-section which shows schematically the display device of FIG. 2;

FIG. 4 is a perspective torn away view which shows schematically a second embodiment of the display device according to the invention including a vertical connection zone moved towards the longitudinal edge of the top substrate plate;

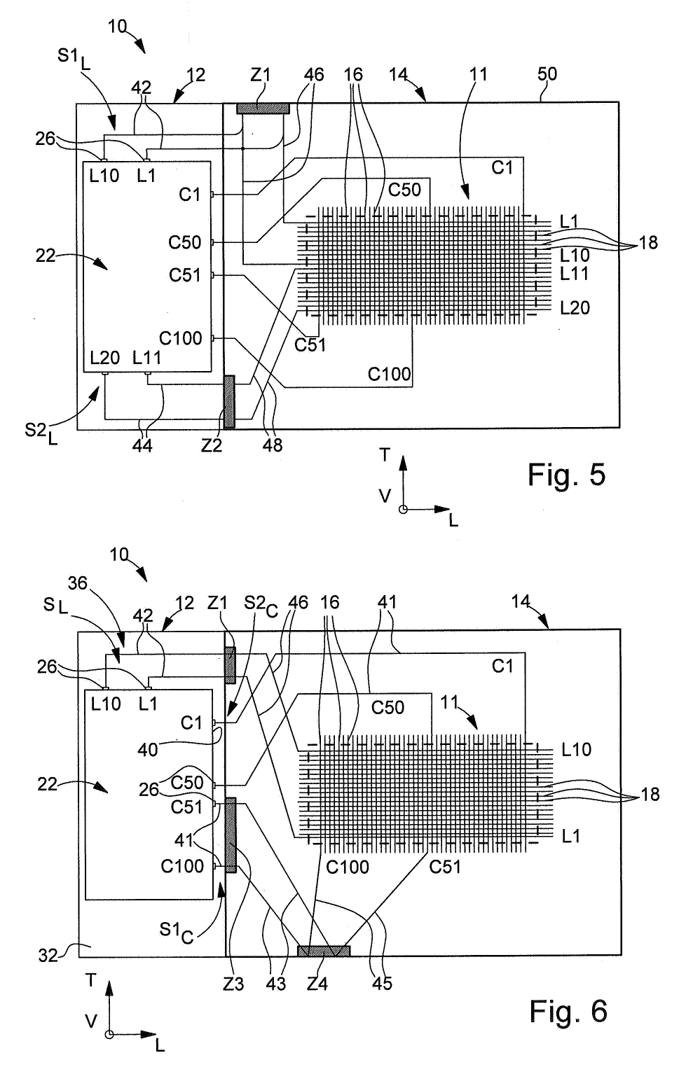

FIG. 5 is a top view which shows schematically the display device of FIG. 4;

FIG. 6 is a similar view to that of FIG. 5 which shows schematically a fourth embodiment of the display device according to the invention wherein part of the conductive paths for connecting the columns is arranged on the top plate;

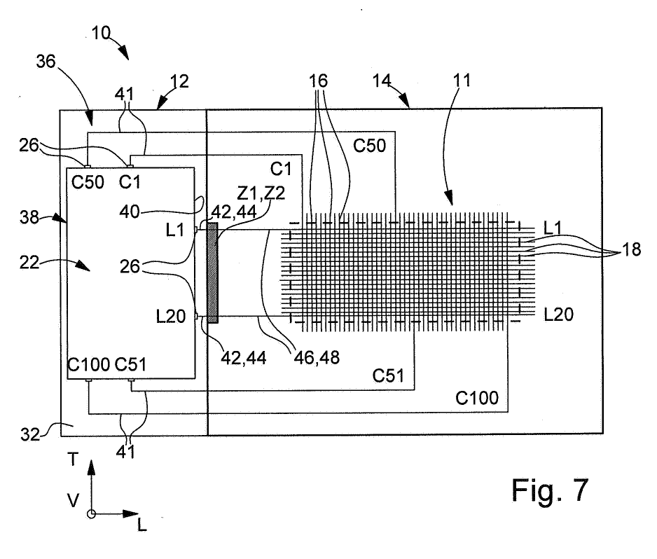

FIG. 7 is a similar view to that of FIG. 5 which shows schematically a fifth embodiment of the display device according to the invention including an improved control circuit.

In the following description, similar or identical elements will be designated by the same references.

In the following description vertical, longitudinal and transverse orientations will be used, in a non-limiting manner, in accordance with the marks V, L, T shown in the Figures.

FIGS. 2 and 3 show an electro-optical matrix display device 10 made in accordance with the teaching of the invention according to a first embodiment.

Display device 10 includes a bottom substrate plate 12 and a top substrate plate 14 of overall rectangular shape, which are bonded to each other so as to trap an electro-optical layer formed here by a layer of liquid crystals. The lengths of plates 12, 14 extend here along the longitudinal direction and the widths of plates 12, 14 extend here along the transverse direction.

The inner faces 32, 34, i.e. the faces oriented towards electro-optical layer 30, of bottom plate 12 and top plate 14 respectively carry a series of N transverse electrodes 16 and a series of M longitudinal electrodes 18 which form a display matrix 11.

Of course, according to an alternative embodiment (not shown), the transverse electrodes 16 could be carried by top plate 14 and the longitudinal electrodes 18 by bottom plate 12.

Moreover, display matrix 11 could be designed to be seen, either from above, through top plate 14, or from below, through bottom plate 12.

By way of example, the display matrix 11 shown includes N=100 transverse electrodes 16 and M=20 longitudinal electrodes 18.

Each intersection of a transverse electrode 16 with a longitudinal electrode 18, in matrix 11, corresponds here to a pixel, such that display matrix 11 forms an active display zone formed of a pixel matrix. However, the invention also applies to a display matrix 11 including one or several physical icons addressed in a similar way to a pixel, i.e. by the intersection of at least one transverse electrode 16 with one longitudinal electrode 18.

In accordance with “chip on glass” (COG) technology, a control circuit 22 is directly fixed to a portion 36 of bottom substrate plate 12, here on its inner face 32, and its connection pads 26 are connected to the two series of electrodes 16, 18 by conductive paths 24. Portion 36 of bottom plate 12 which carries control circuit 22 is not covered by top plate 14.

In accordance with the teaching of the invention, control circuit 22 is arranged on a longitudinal end portion 36 of bottom plate 12, here the left end in FIG. 2.

Control circuit 22 has the overall shape of a rectangular plate comprising a main, generally transverse, edge 40 which is arranged on the side of display matrix 11. Main edge 40 is provided with a series S_{C} of connection pads 26 dedicated to addressing columns C.

Control circuit 22 comprises, on either side of main edge 40, a first series S¹L and a second series S2_{L} of connection pads 26 dedicated to addressing lines L. According to the embodiment shown here, the connection pads 26 of the first series S1_{L}, at the top of FIG. 2, are dedicated to addressing lines 1 to M/2 and those of the second series S²L, at the bottom of FIG. 2, are dedicated to addressing lines M/2+1 to M.

It will be noted that it is possible to use only the first series S1_{L} of connection pads 26 if it comprises a sufficient number of connection pads 26 to address all of lines L of display matrix 11.

According to another feature of the invention, connection pads 26 addressing columns C are connected to transverse electrodes 16 and connection pads 26 addressing lines L are connected to longitudinal electrodes 18.

Transverse electrodes 16 are electrically connected to series S_{C} of connection pads 26 addressing columns C by conductive paths 41 arranged on inner face 32 of bottom plate 12.

According to the embodiment shown here, a first series S1_{C} of connection pads 26 addressing half of columns C is connected to transverse electrodes 16 of one side of matrix 11, at the bottom of FIG. 2, and a second series S2_{C} of connection pads 26 addressing the other half of columns C is connected to transverse electrodes 16 of the other side of matrix 11, at the top of FIG. 2.

This type of connection enables the transverse space requirement due to conductive paths 41 to be distributed on either side of matrix 11.

In order to allow connection pads 26 addressing lines L, which are carried by bottom plate 12, to be electrically connected to longitudinal electrodes 18, which are carried by top plate 14, first Z1 and second Z2 vertical connection zones are provided, arranged in proximity to the peripheral edge of top plate 14. These vertical connection zones Z1, Z2 comprise here an anisotropic conductive adhesive material which conducts the electrical current vertically only. This adhesive material is deposited over the entire peripheral edge of top plate 14 to fix top plate 14 onto bottom plate 12. The adhesive material is made anisotropically conductive for example by means of conductive balls. This connection technology can be called “contact in seal”.

Of course, vertical connection zones Z1, Z2 could be achieved by other means, for example by contact points arranged in a suitable manner.

Each of vertical connection zones Z1, Z2 extend here over a transverse segment of the peripheral edge of top plate 14, at the border between top plate 14 and the longitudinal end portion 36 that is not covered by bottom plate 12.

A first series of bottom conductive paths 42 is arranged on inner face 32 of bottom plate 12 so as to electrically connect the first series S1_{L} of connection pads 26 addressing lines L to the first vertical connection zone Z1.

A second series of bottom conductive paths 44 is arranged on inner face 32 of bottom plate 12 so as to electrically connect the second series S2_{L} of connection pads 26 addressing lines L to the second vertical connection zone Z2.

Likewise, a first series of top conductive paths 46 is arranged on inner face 34 of top plate 14 so as to electrically connect the longitudinal electrodes 18 corresponding to lines M/2 to first vertical connection zone Z1

A second series of top conductive paths 48 is arranged on inner face 34 of top plate 14 so as to electrically connect the longitudinal electrodes 18 corresponding to lines M/2+1 to M to second vertical connection zone Z2.

It should be noted that in order to facilitate comprehension of the diagrams, conductive paths 41, 42, 44, 46, 48 and connection pads 26 have been partially shown.

It will be noted that conductive paths 41 connected to columns C intersect connective paths 46, 48 connected to lines L outside display matrix 11. These intersections are possible, without any short-circuit problems, since they occur in a zone where conductive paths 46, 48 connected to lines L are carried by top plate 14. These intersections can cause pixels to be activated in the active crystals, outside display matrix 11. However, this activation is not detrimental since it occurs outside the active display zone formed by matrix 11.

The display device 10 obtained according to the first embodiment has the advantage of being particularly compact widthways, here along the transverse direction. Moreover, it is compatible with a conventional control circuit 22, i.e. of the type used in display devices according to the state of the art, which minimises the manufacturing and referencing costs.

Other embodiments of display device 10 according to the invention will now be presented. These embodiments will be described mainly as a function of their differences as regards the first embodiment.

Referring to FIG. 2, which shows the first embodiment, it will be noted that connection pads 26 addressing lines 1 to M/2 are connected to a first half of longitudinal electrodes 18, respectively from inner electrode 18 to outer electrode 18, whereas the connection pads addressing lines M/2+1 to M are connected to a second half of longitudinal electrodes 18, respectively from inner electrode 18 to outer electrode 18. Consequently, the order of connection pads 26 addressing lines L does not follow the physical order of longitudinal electrodes 18 in matrix 11, which makes programming control circuit 22 more difficult.

The second embodiment of display device 10 according to the invention, which is shown in FIGS. 4 and 5, overcomes this drawback by proposing a display device 10 wherein the first vertical connection zone Z1 no longer extends transversely but longitudinally along the peripheral edge of top plate 14.

Thus, the first series S1L of bottom conductive paths 42 extends under top plate 14 so as to reach the closest longitudinal edge 50 of conductive plate 14, where the first vertical connection zone Z1 is located. The associated top conductive paths 46 go from this longitudinal edge 50 towards the corresponding longitudinal electrodes 18, with a reverse order relative to the first embodiment.

Owing to this configuration, the connection pads 26 addressing lines 1 to M/2 are connected in ascending order to longitudinal electrodes 18, from the outside of display matrix 11 inwards.

According to a third embodiment (not shown) of the invention, control circuit 22 includes an reversal device which is operated for reversing the order of the first series S1_{L} of connection pads 26 addressing lines 1 to M/2, which enables the order of connection pads 26 addressing lines L to be made to match the physical order of longitudinal electrodes 18 in matrix 11.

Advantageously, control circuit 22 also includes an inverting device which is operated to invert the order of connection pads 26 addressing columns N/2+1 to N, which also enables the order of connection pads 26 addressing columns C to be made to match the physical order of transverse electrodes 16 in matrix 11.

Preferably, these inverting devices are achieved by means of electronic components integrated in control circuit 22 and can be controlled in a reversed mode and in a normal mode, which enables control circuit 22 to be used in a display device 10 that does not require reversal of the order of connection pads 26.

FIG. 6 shows a fourth embodiment of display device 10 according to the invention, wherein the addressing order of the first series S1_{C} of connection pads 26 addressing columns N/2+1 to N has been reversed by connecting them to the corresponding transverse electrodes 16 passing through top plate 14.

The conductive paths 41 connect connection pads 26 of the first series S1_{C} to a third vertical connection zone Z3 which extends transversely. This third vertical connection zone Z3 is connected, by conductive paths 43 carried by top plate 14, to a fourth vertical connection zone Z4, which extends longitudinally and which returns addressing data down to bottom plate 12, where conductive paths 45 form the connection with the corresponding transverse electrodes 16.

The reversal of the addressing order of connection pads 26 of the first series S1_{C} is achieved along the same principle as that used in the second embodiment (FIG. 5), for reversing the addressing order of the first series S1_{L} of pads 26 addressing lines L.

Of course, connection pads 26 of the second series S2_{C} addressing columns C are connected to the corresponding transverse electrodes 16 as in the embodiments previously described, without passing through top plate 14.

According to this fourth embodiment, matrix 11 has only ten lines L which are addressed by a single series S_{L} of connection pads 26 addressing lines L, located on only one side of connection pads 26 addressing columns C. These connection pads 26 are connected to longitudinal electrodes 18 via a single vertical connection zone Z1, such that it is not necessary to reverse the addressing order as in the second embodiment (FIG. 5).

According to a fifth embodiment of display device 10 according to the invention, which is shown in FIG. 7, the latter is fitted with a control circuit 22 comprising connection pads 26 dedicated to addressing lines L on its main edge 40, connection pads 26 dedicated to addressing columns C being distributed here over the longitudinal edges of control circuit 22, on either side of main edge 40.

As for the preceding embodiments, the connection pads 26 addressing columns C are connected to transverse electrodes 16 and the connection pads 26 addressing lines L are connected to longitudinal electrodes 18.

It will be noted that bottom conductive paths 42, 44 could be connected to top conductive paths 46, 48 at the heart of the same vertical connection zone Z1, Z2.

This embodiment provides a display device 10 that is even more compact, both in the longitudinal direction and in the transverse direction, owing to a simpler conductive path connection diagram, which avoids intersections of conductive paths 41, 42, 44, 46, 48 outside display matrix 11.

Moreover, this embodiment enables the order of all of connection pads 26 to be made to match the physical order of transverse electrodes 16 and longitudinal electrodes 18 in matrix 11.

According to a variant of this fifth embodiment, control circuit 22 includes electronic means that make the connection pads 26 arranged on the main edge 40 able to address columns C of matrix 11 and which make the connection pads 26 arranged on the longitudinal edges able to address lines L of matrix 11. Moreover, control circuit 22 includes selection means which are operated to assign a determined type of dedicated addressing to each series of connection pads 26.

The selection means include for example two states: a first state in which the connection pads 26 of main edge 40 are dedicated to addressing columns C, the other connection pads 26 addressing lines L, and a second state in which the connection pads 26 of main edge 40 are dedicated to addressing columns L, the other connection pads 26 addressing lines C.

In order to make display device 10 of FIG. 7, the selection means are then operated in the second state.

1. An electro-optical matrix display device including at least one bottom substrate plate of overall rectangular shape carrying an electro-optical layer, a series of N transverse electrodes and a series of M longitudinal electrodes forming a display matrix, and including a control circuit which is fixed to the bottom substrate plate and which includes connection pads connected to the two series of electrodes by conductive paths, one part of the connection pads being dedicated to addressing the columns of the matrix and another part of the connection pads being dedicated to addressing the lines of the matrix,
wherein the control circuit is arranged on a longitudinal end portion of the bottom substrate plate, and in that the connection pads addressing the columns are connected to the transverse electrodes and the connection pads addressing the lines are connected to the longitudinal electrodes.

2. A display device according to claim 1, wherein the electro-optical layer is trapped between the bottom substrate plate and a top substrate plate, wherein the longitudinal end portion that carries the control circuit is not covered by the top substrate plate, and wherein one of the two series of electrodes is arranged on the inner face of the bottom plate, the other series being arranged on the inner face of the top plate and wherein at least one vertical connection zone is arranged in proximity to the peripheral edge of the top plate so as to electrically connect the conductive paths linked to the electrodes carried by the top plate to the conductive paths linked to the corresponding connection pads of the control circuit.

3. The display device according to claim 2, wherein the transverse electrodes are arranged on the inner face of the bottom plate and the longitudinal electrodes are arranged on the inner face of the top plate.

4. The display device according to claim 2, wherein the transverse electrodes are arranged on the inner face of the top plate and the longitudinal electrodes are arranged on the inner face of the bottom plate.

5. The display device according to claim 1, wherein the control circuit includes an overall transverse main edge which is arranged on the side of the display matrix, wherein the connection pads addressing the columns are arranged on said main edge, and wherein the connection pads addressing the lines are arranged at least on one side of the connection pads addressing the columns.

6. The display device according to claim 2, wherein the control circuit includes an overall transverse main edge which is arranged on the side of the display matrix, wherein the connection pads addressing the columns are arranged on said main edge, and wherein the connection pads addressing the lines are arranged at least on one side of the connection pads addressing the columns

7. The display device according to claim 6, wherein the display device includes a first and a second vertical connection zones respectively associated with a first and a second series of connection pads, and wherein the first vertical connection zone extends longitudinally overall such that the first series of connection pads is connected in ascending order to the corresponding electrodes from the exterior towards the interior of the matrix.

8. The display device according to claim 6, wherein the electrodes carried by the top plate are connected to the corresponding connection pads via a first vertical connection zone, wherein a first part of the electrodes carried by the bottom plate is connected to the corresponding connection pads by passing through the top plate by means of a third and a fourth successive vertical connection zones, the third vertical connection zone extending transversely overall and the fourth vertical connection zone extending longitudinally overall, and wherein the second part of the electrodes carried by the bottom plate is connected to the corresponding connection pads without passing through the top plate, such that the physical order of the electrodes carried by the bottom plate corresponds to the addressing order of the corresponding connection pads.

9. The display device according to claim 5, wherein the control circuit includes an inverting device for reversing the addressing order of one part of the connection pads addressing the lines.

10. The display device according to claim 5, wherein the control circuit includes an inverting device for reversing the addressing order of one part of the connection pads addressing the columns.

11. The display device according to claim 1, wherein the control circuit includes an overall transverse main edge which is arranged on the side of the display matrix and which is fitted with a series of connection pads dedicated to addressing the lines, connection pads dedicated to addressing the columns being arranged on at least one side of said series of connection pads addressing the lines.

12. The display device according to claim 1, wherein the electro-optical layer is a layer of liquid crystals.

13. The display device according to claim 2, wherein the vertical connection zones includes an anisotropic adhesive material that conducts the electric current vertically only.

14. A control circuit for a display device according to claim 5, wherein the control circuit includes an inverting device which is operated to reverse the addressing order of one part of the connection pads addressing the lines.

15. A control circuit for a display device according to claim 5, wherein the control circuit includes an inverting device which is operated to reverse the addressing order of one part of the connection pads addressing the columns.

16. A control circuit for a display device according to claim 1, wherein the control circuit includes an overall transverse main edge which is arranged on the side of the display matrix and which is provided with a first series of connection pads, dedicated to addressing the lines, connection pads dedicated to addressing the columns being arranged on at least one side of said first series of connection pads addressing the lines.

17. A control circuit for a display device according to claim 1, of the type including an overall transverse main edge which is arranged on the side of the display matrix and which is provided with a first series of connection pads, a second series of connection pads being arranged on at least one side of said first series, wherein the control circuit includes electronic means that make each series of connection pads able to address the lines and the columns of the matrix, and selection means that are operated to assign a determined type of dedicated addressing to each series of connection pads, and wherein the first series is assigned to addressing the lines and the second series is assigned to addressing the columns.
